(19) United States
(12) Patent Application Publication
(10) Pub. No.: US 2025/0306188 A1
(43) Pub. Date: Oct. 2, 2025

(54) FMCW LIDAR AND SCANNING METHOD THEREFOR

(71) Applicant: HESAI TECHNOLOGY CO., LTD., Shanghai (CN)

(72) Inventors: Hailong HE, Shanghai (CN); Zhengqing PAN, Shanghai (CN); Kai SUN, Shanghai (CN); Shaoqing XIANG, Shanghai (CN)

(21) Appl. No.: 19/235,984

(22) Filed: Jun. 12, 2025

Related U.S. Application Data
(63) Continuation of application No. PCT/CN2023/138131, filed on Dec. 12, 2023.

(30) Foreign Application Priority Data
Dec. 12, 2022 (CN) 202211597331.9

(51) Int. Cl. G01S 7/493; G01S 7/481; G01S 7/4911; G01S 7/4912; G01S 17/34

(52) U.S. Cl. CPC G01S 7/493; G01S 7/4811; G01S 7/4815; G01S 7/4817; G01S 7/4911; G01S 7/4917; G01S 17/34

(57) ABSTRACT

An FMCW LiDAR includes a transceiver, a beam shaper, a scanner, and a controller. The transceiver includes multiple ports arranged at least along a first direction. The transceiver is configured to transmit a detection light at a predetermined time sequence and receive an echo light of the detection light being reflected off an object. The beam shaper is configured to collimate the detection light and converge the echo light onto the transceiver. The scanner is configured to be rotate around an axis to reflect the detection light from the beam shaper to a target space, and reflect the echo light to the beam shaper. The controller electrically connected to the scanner, and configured to control the scanner to switch between multiple scanning modes. The scanner has different rotation speeds and/or swing amplitudes in different scanning modes. The adjacent-time ports transmit the detection light at a same predetermined time interval.

### CROSS-REFERENCE TO RELATED APPLICATION(S)

This application is a continuation application of PCT application No. PCT/CN2023/138131, filed on Dec. 12, 2023, which claims priority to Chinese Patent Application No. 202211597331.9, filed on Dec. 12, 2022, the content of which are incorporated herein by reference in their entireties.

### TECHNICAL FIELD

This disclosure relates to the field of LiDAR, in particular to FMCW LiDARs and scanning methods for the FMCW LiDAR.

### BACKGROUND

A frequency modulated continuous wave (“FMCW”) LiDAR can transmit frequency modulated continuous laser as detection light. There can be a frequency shift between an echo signal reflected by an object (e.g., an obstacle) and the corresponding light signal. By measuring the frequency shift, the distance and velocity of the object can be detected. Typically, the FMCW LiDAR can use scanning mirrors to scan. The laser transmitted by the laser can be deflected by the scanning mirror rotating over time. Scanning within a certain field of view (“FOV”) can be achieved.

The detection light beams at different angles radiate from the LiDAR. The farther the distance from the LiDAR is, the greater the distance between detection light beams at different angles is. This leads to a decrease in the resolution of the LiDAR for distant targets. The number of points of the distant targets in the point cloud is very small or even zero. For example, if there is a tire lying on the road surface 250 m away on a highway (e.g., the width of the tire is about 195 mm and the diameter is about 800 mm), and the resolution of the point cloud in both horizontal and vertical directions is less than 0.2°, the tire can form at most 2 points in the point cloud. The 2 points are not enough for target classification and recognition. The probability of detecting the tire is low.

In addition, the scanning speed of the scanning mirror can be increased to increase the FOV. When the light reflected by a distant target is incident to the LiDAR, the scanning mirror has already rotated over a certain angle. The focus position after the echo light can be converged by the optical components to shift. The shift angle can be called a delay angle. The faster the scanning mirror rotates, the larger the delay angle can be. The energy of the echo light can be reduced. The signal-to-noise ratio and the long-distance measurement capability can also be reduced. Therefore, the long-distance measurement capability of the FMCW LiDAR can be negatively correlated with the scanning speed. For example, under the condition of a fixed scanning frequency, the larger the FOV is, the shorter the measurement range is.

### SUMMARY

In a first aspect, this disclosure provides a FMCW LiDAR. The FMCW LiDAR includes a transceiver device, a beam shaper device, a scanner device, and a controller device. The transceiver device includes multiple (e.g., a plurality of) ports arranged at least along a first direction. The transceiver device is configured to transmit a detection light at a predetermined time sequence respectively and receive an echo light of the detection light being reflected off an object. The beam shaper device is configured to collimate the detection light and converge the echo light onto the transceiver device. The scanner device is configured to rotate around at least one axis to reflect the detection light from the beam shaper device to a target space, and reflect the echo light to the beam shaper device. The controller device is electrically connected to the scanner device and configured to control the scanner device to switch between multiple (e.g., a plurality of) scanning modes. The scanner device has different rotation speeds and/or swing amplitudes in different scanning modes. Adjacent-time ports transmit the detection light at a predetermined time interval.

Optionally, the multiple ports are configured to transmit the detection light at the predetermined time interval sequentially.

Optionally, the multiple ports are divided into multiple (e.g., a plurality of) groups, and respective groups of the ports transmit the detection light at the predetermined time interval sequentially.

Optionally, the scanner device has a first axis, and the scanner device rotates around the first axis to reflect the detection light to different angles in a first plane. The first axis is parallel to the first direction, and the first plane is perpendicular to the first direction.

Optionally, the swing amplitude of the scanner device corresponds to a range for FOV angle of the FMCW LiDAR in the first plane.

Optionally, the rotation speed of the scanner device is related to a range for FOV angle of the FMCW LiDAR in the first plane in current scanning mode, a maximum measurement range, a scanning period, a focal length of the beam shaper device, and mode field diameter of the ports.

Optionally, the rotation speed of the scanner device in different scanning modes satisfies the following relationship:

$$\frac{2 z ω}{c} \cdot f = \frac{4 z \cdot HFOV}{c \cdot T} < \frac{{D}_{fiber}}{2}$$

where z represents the maximum measurement range of the FMCW LiDAR, ω represents an optical angular velocity of the scanner device, c represents a light speed, f represents the focal length of the beam shaper device, HFOV represents the range for FOV angle of the FMCW LiDAR in the first plane in current scanning mode, T represents the scanning period, and Dfiber represents the mode field diameter of the ports.

Optionally, the multiple scanning modes at least includes a first scanning mode and a second scanning mode. The scanner device has a first rotation speed and a first swing amplitude in the first scanning mode, and the scanner device has a second rotation speed and a second swing amplitude in the second scanning mode. The first rotation speed is greater than the second rotation speed, and the first swing amplitude is greater than the second swing amplitude.

Optionally, the controller device is further configured to switch the scanning mode based on one or more of a detection range, a detection result, or a detection scene.

Optionally, the controller device is configured to switch the scanning mode based on one or more of the following schemes: switching to the second scanning mode when a moving speed of the FMCW LiDAR exceeds a speed threshold; switching to the first scanning mode when the moving speed is below the speed threshold; switching to the second scanning mode when a distance between an object and the FMCW LiDAR exceeds a predetermined distance threshold, or when the number of point clouds obtained by detecting an object through the FMCW LiDAR is lower than a predetermined point number threshold; alternately switching between the first scanning mode and the second scanning mode based on a predetermined period.

Optionally, the transceiver device further includes a beam splitter module and an isolation module. The beam splitter module is coupled to a light source of the FMCW LiDAR and is configured to split the light signal into a local oscillator light and the detection light. The isolation module is configured to receive and output the detection light and receive the echo light, and separate an optical path of the echo light from an optical path of the detection light.

Optionally, the FMCW LiDAR further includes a detector device coupled to the transceiver device. The detector device is configured to receive the local oscillator light and the echo light and convert a light signal into an electrical signal.

Optionally, the FMCW LiDAR further includes a data processor configured to sample the electrical signal output by the detector device, sampling-start times in different scanning modes are different, and durations of sampling in different scanning modes are the same.

Optionally, the sampling-start time is related to a maximum measurement range of the FMCW LiDAR in a corresponding scanning mode.

Optionally, the controller device is further configured to switch between different scanning modes when the scanner device is at a 0° position.

Optionally, the scanner device includes: a reflecting mirror; and a driver module configured to drive the reflecting mirror to rotate around the axis. The controller device is connected to the driver module and configured to control a current/voltage of the driver module based on the scanning modes to change a rotation speed and/or a swing amplitude of the reflecting mirror.

Optionally, the driver module includes a resonant motor, the resonant motor includes a rotor and a stator, and the rotor rotates around the axis between an equilibrium position and a maximum swing amplitude. The rotor includes a magnetic ring, the magnetic ring includes multiple (e.g., a plurality of) pairs of magnets distributed along a circumferential direction. The stator includes a coil assembly and a restoring component, the coil assembly includes multiple (e.g., a plurality of) winding coils distributed along the circumferential direction of the magnetic ring, and the restoring component is configured to restore the rotor to the equilibrium position around the axis.

In a second aspect, this disclosure also provides a scanning method for a FMCW LiDAR, the FMCW LiDAR includes a transceiver device, a scanner device and a controller device, The transceiver device includes multiple ports arranged at least along the first direction, the scanning methods including: transmitting detection light by the ports; collimating the detection light by a beam shaper device; reflecting and emitting the detection light to a target space by the scanner device; controlling the scanner device to switch between multiple scanning modes by the controller device. The scanner device has different rotation speeds and/or swing amplitudes in different scanning modes. The adjacent-time ports transmit the detection light at a same predetermined time interval.

Optionally, the multiple ports transmit the detection light at the predetermined time interval sequentially.

Optionally, the multiple ports are divided into multiple groups, and respective groups of the ports transmit the detection light at the predetermined time interval sequentially.

Optionally, the port is further configured to receive echo light of the detection light reflected off an object. The scanner device reflects the echo light to the beam shaper device, and the beam shaper device converges the echo light to the port.

Optionally, the rotation speed of the scanner device is related to a range for FOV angle of the FMCW LiDAR in current scanning mode, a maximum measurement range, a scanning period, a focal length of the beam shaper device, and mode field diameter of the ports.

Optionally, the rotation speed of the scanner device in different scanning modes satisfies the following relationship:

$$\frac{2 z ω}{c} \cdot f = \frac{4 z \cdot HFOV}{c \cdot T} < \frac{{D}_{fiber}}{2}$$

where z represents the maximum measurement range of the FMCW LiDAR, œ represents an optical angular velocity of the scanner device, c represents a light speed, f represents the focal length of the beam shaper device, HFOV represents the range for FOV angle of the FMCW LiDAR in the first plane in current scanning mode, T represents the scanning period, and Dfiber represents the mode field diameter of the ports.

Optionally, the multiple scanning modes includes a first scanning mode and a second scanning mode, the scanner device has a first rotation speed and a first swing amplitude in the first scanning mode, and the scanner device has a second rotation speed and a second swing amplitude in in the second scanning mode. The first rotation speed is greater than the second rotation speed, and the first swing amplitude is greater than the second swing amplitude.

Optionally, the step of switching the scanner device between multiple scanning modes includes switching the scanning mode based on one or more of a detection range, a detection result or a detection scene.

Optionally, the predetermined condition includes one or more of the following: switching to the second scanning mode when a moving speed of the FMCW LiDAR exceeds a speed threshold; switching to the first scanning mode when the moving speed is below the speed threshold; switching to the second scanning mode when a distance between an object and the FMCW LiDAR exceeds a predetermined distance threshold, or when the number of point clouds obtained by detecting an object through the FMCW LiDAR is lower than a predetermined point number threshold; alternately switching between the first scanning mode and the second scanning mode based on a predetermined period.

Optionally, the scanning method further includes sampling the electrical signal output by the detector device, sampling-start times in different scanning modes are different, durations of sampling in different scanning modes are the same, and the sampling-start time is related to a maximum measurement range of the FMCW LiDAR in a corresponding scanning mode.

Optionally, the step of controlling the scanner device to switch between the multiple scanning modes includes to switch between different scanning modes when the scanner device is at a 0° position.

In a third aspect, this disclosure provides a LiDAR. The LiDAR includes a transceiver, a beam shaper, a scanner, a controller. The transceiver includes a plurality of ports arranged along a first direction. The transceiver is configured to transmit a detection light based on a predetermined time sequence and receive an echo light of the detection light being reflected off an object. The beam shaper configured to collimate the detection light and converge the echo light onto the transceiver. The scanner is configured to rotate around an axis to reflect the detection light from the beam shaper to a target space and reflect the echo light to the beam shaper. The controller electrically connected to the scanner, and configured to control the scanner to switch among a plurality of scanning modes, wherein the scanner has different rotation speeds or swing amplitudes in different scanning modes, wherein adjacent-time ports are configured to transmit the detection light at a predetermined time interval.

Optionally, the plurality of ports are configured to transmit the detection light at the predetermined time interval sequentially.

Optionally, the plurality of ports are divided into a plurality of groups, and a port in each of the plurality of groups is configured to transmit the detection light at the predetermined time interval sequentially.

Optionally, the scanner includes a first axis, and the scanner is configured to rotate around the first axis to reflect the detection light to different angles in a first plane, wherein the first axis is parallel to the first direction, and the first plane is perpendicular to the first direction.

Optionally, a swing amplitude of the scanner corresponds to a range of FOV angles of the LiDAR in the first plane.

Optionally, a rotation speed of the scanner is related to a range of FOV angles of the LiDAR in the first plane in a current scanning mode, a maximum measurement range, a scanning period, a focal length of the beam shaper, and a mode field diameter of the ports.

Optionally, the rotation speed of the scanner in different scanning modes satisfies:

$$\frac{2 z ω}{c} \cdot f = \frac{4 z \cdot HFOV}{c \cdot T} < \frac{{D}_{fiber}}{2}$$

where z represents the maximum measurement range of the LiDAR, @ represents an optical angular velocity of the scanner, c represents a light speed, f represents the focal length of the beam shaper, HFOV represents the range for FOV angle of the LiDAR in the first plane in current scanning mode, T represents the scanning period, and Dfiber represents the mode field diameter of the ports.

Optionally, the plurality of scanning modes include a first scanning mode and a second scanning mode, the scanner has a first rotation speed and a first swing amplitude in the first scanning mode, and the scanner has a second rotation speed and a second swing amplitude in the second scanning mode, wherein the first rotation speed is greater than the second rotation speed, and the first swing amplitude is greater than the second swing amplitude.

Optionally, the controller is further configured to switch the plurality of scanning modes based on at least one of a detection range, a detection result, or a detection scene.

Optionally, the controller is further configured to switch the plurality of scanning modes based on at least one of: switching to the second scanning mode when a moving speed of the LiDAR exceeds a speed threshold; switching to the first scanning mode when the moving speed is below the speed threshold; switching to the second scanning mode when a distance between the object and the LiDAR exceeds a predetermined distance threshold; switching to the second scanning mode when a number of point clouds determined by detecting the obstacle through the LiDAR is lower than a predetermined point number threshold; or alternately switching between the first scanning mode and the second scanning mode based on a predetermined period.

Optionally, the transceiver further includes a beam splitter and an isolator. The beam splitter is coupled to a light source of the LiDAR and configured to split a light signal into a local oscillator light and the detection light, and the isolator is configured to receive and output the detection light, receive the echo light, and separate an optical path of the echo light from an optical path of the detection light.

Optionally, the LiDAR further includes a detector coupled to the transceiver, wherein the detector is configured to receive the local oscillator light and the echo light and convert a light signal into an electrical signal.

Optionally, further includes a data processor configured to sample the electrical signal outputted by the detector, wherein starting times of sampling in different scanning modes are different, and durations of sampling in different scanning modes are the same.

Optionally, a starting time of sampling is related to a maximum measurement range of the LiDAR in a corresponding scanning mode.

Optionally, the controller is further configured to switch between different scanning modes when the scanner is at a 0° position.

Optionally, the scanner includes a reflecting mirror; and a driver configured to drive the reflecting mirror to rotate around the axis, wherein the controller is connected to the driver and configured to control a current or a voltage of the driver based on the scanning modes to change at least one of a rotation speed or a swing amplitude of the reflecting mirror.

Optionally, the driver includes a resonant motor, the resonant motor includes a rotor and a stator, and the rotor is configured to rotate around the axis between an equilibrium position and a maximum swing amplitude.

Optionally, the rotor includes a magnetic ring, the magnetic ring includes a plurality of pairs of magnets distributed along a circumferential direction; and the stator includes a coil assembly and a restoring component, the coil assembly includes a plurality of winding coils distributed along the circumferential direction of the magnetic ring, and the restoring component is configured to restore the rotor to the equilibrium position around the axis.

Optionally, further includes a data processor configured to sample the electrical signal outputted by the detector, wherein starting times of sampling in different scanning modes are different, and durations of sampling in different scanning modes are the same.

In a fourth aspect, this disclosure provides a terminal device includes: LiDAR described in above embodiments and a connector, configured to connect the LiDAR and the terminal device. Optionally, the terminal device includes a car, a drone or a robot.

In some embodiments, ports of the transceiver device that are adjacent in the time sequence transmit the detection light at the same predetermined time interval, and the scanner device of the FMCW LiDAR is switched between different scanning modes by changing the rotation speed and/or swing amplitude of the scanner device, so that the FMCW LiDAR can switch between different scanning modes based on different detection requirements and thus achieve different detection effects.

### BRIEF DESCRIPTION OF THE DRAWINGS

The accompanying drawings, which form part of this disclosure, are provided to further understand this disclosure. The example embodiments and the descriptions thereof are used to explain this disclosure, which do not form improper limitations on this disclosure. In the drawings:

FIG. 1 shows a front view of an example FMCW LiDAR, consistent with some embodiments of this disclosure.

FIG. 2 shows a top view of the example FMCW LiDAR, consistent with some embodiments of this disclosure.

FIG. 3 shows an example scanning curve of the detection beam of the example FMCW LiDAR, consistent with some embodiments of this disclosure.

FIG. 4 shows an example schematic diagram illustrating generation of a delay angle of the LiDAR, consistent with some embodiments of this disclosure.

FIG. 5A shows an example first scanning mode of the scanner device, consistent with some embodiments of this disclosure.

FIG. 5B shows an example second scanning mode of the scanner device, consistent with some embodiments of this disclosure.

FIG. 6 shows a diagram illustrating an example structure of a FMCW LiDAR, consistent with some embodiments of this disclosure.

FIG. 7 shows an example including a sampling start time and duration in the first scanning mode and the second scanning mode, consistent with some embodiments of this disclosure.

FIG. 8 shows an example deviation between a target angle and an actual angle when switching scanning modes arbitrarily, consistent with some embodiments of this disclosure.

FIG. 9 shows an example deviation between the target angle and the actual angle when switching scanning modes, consistent with some embodiments of this disclosure.

FIG. 10 shows a schematic diagram illustrating an example resonant motor, consistent with some embodiments of this disclosure.

FIG. 11 shows an example normalized curve of scanning speed in a scanning mode with a large FOV.

FIG. 12 shows an example normalized curve of scanning speed in a scanning mode with a small FOV.

FIG. 13 shows an example scanning method for FMCW LiDAR, consistent with some embodiments of this disclosure.

### DETAILED DESCRIPTION

In the following, some example embodiments are described. The described embodiments can be modified in various different ways without departing from the spirit or scope of this disclosure, as would be apparent to those skilled in the art. Accordingly, the drawings and descriptions are to be regarded as illustrative and not restrictive.

In the description of this disclosure, it needs to be understood that the orientation or position relations represented by such terms as “central” “longitudinal” “latitudinal” “length” “width” “thickness” “above” “below” “front” “rear” “left” “right” “vertical” “horizontal” “top” “bottom” “inside” “outside” “clockwise” “counterclockwise” and the like are based on the orientation or position relations as shown in the accompanying drawings, and are used only for the purpose of facilitating description of this disclosure and simplification of the description, instead of indicating or suggesting that the represented devices or elements must be oriented specifically, or configured or operated in a specific orientation. Thus, such terms should not be construed to limit this disclosure. In addition, such terms as “first” and “second” are only used for the purpose of description, rather than indicating or suggesting relative importance or implicitly indicating the number of the represented technical features. Accordingly, features defined with “first” and “second” can, expressly or implicitly, include one or more of the features. In the description of this disclosure, “plurality” means two or more, unless otherwise defined explicitly and specifically.

In the description of this disclosure, it needs to be noted that, unless otherwise specified and defined explicitly, such terms as “installation” “coupling” and “connection” should be broadly understood as, for example, fixed connection, detachable connection, or integral connection; or mechanical connection, electrical connection or intercommunication; or direct connection, or indirect connection via an intermediary medium; or internal communication between two elements or interaction between two elements. For those skilled in the art, the specific meanings of such terms herein can be construed in light of the specific circumstances.

Herein, unless otherwise specified and defined explicitly, if a first feature is “on” or “beneath” a second feature, this can cover direct contact between the first and second features, or contact via another feature therebetween, other than the direct contact. Furthermore, if a first feature is “on”, “above”, or “over” a second feature, this can cover the case that the first feature is right above or obliquely above the second feature, or just indicate that the level of the first feature is higher than that of the second feature. If a first feature is “beneath”, “below”, or “under” a second feature, this can cover the case that the first feature is right below or obliquely below the second feature, or just indicate that the level of the first feature is lower than that of the second feature.

The disclosure provides many different embodiments or examples. To simplify the disclosure, the following gives the description of the parts and arrangements embodied in some examples. They are only for the example purpose, not intended to limit this disclosure. Besides, this disclosure can repeat a reference number and/or reference letter in different examples, and such repeat is for the purpose of simplification and clarity, which does not represent any relation among various embodiments and/or arrangements as discussed. In addition, this disclosure provides examples of various example processes and materials, but those skilled in the art can also be aware of application of other processes and/or use of other materials.

Some example embodiments of this disclosure are described below with reference to the drawings. It should be appreciated that the example embodiments described here are only for the purpose of illustrating and explaining, instead of limiting, this disclosure.

This disclosure provides a FMCW LiDAR. The scanning mode of the FMCW LiDAR can be adjustable. The FMCW LiDAR can include a transceiver device, a beam shaper device, a scanner device and a controller device. The transceiver device can include multiple (e.g., a plurality of) ports arranged at least along a first direction. The transceiver device can transmit a detection light in a predetermined time sequence. The transceiver device can receive an echo light of the detection light reflected off an object. The beam shaper device can collimate the detection light and converge the echo light onto the transceiver device. The scanner device can be rotatable around at least one axis. The scanner device can reflect the detection light from the beam shaper device to a target space, and reflect the echo light to the beam shaper device. The controller device can be electrically connected to the scanner device. The controller device can control the scanner device to switch between multiple scanning modes. The scanner device can have different rotation speeds and/or swing amplitudes in different scanning modes. The ports with adjacent or consecutive firing times in a time sequence can transmit the detection light at a same predetermined time interval. For simplicity, such ports are referred to as “adjacent-time port” in this disclosure. The scanner device of the FMCW LiDAR can be switched among different scanning modes by changing the rotation speed and/or swing amplitude of the scanner device. In this disclosure, the complexity in controlling the light source and transceiver device of the LiDAR can be reduced. Different detection effects can be achieved.

Some embodiments of this disclosure are described in detail below.

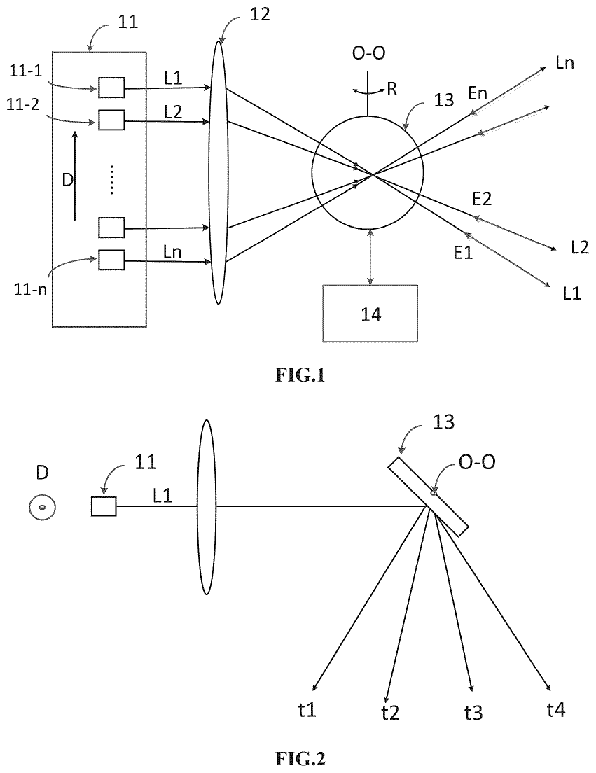

FIG. 1 shows a front view of an example FMCW LiDAR, consistent with some embodiments of this disclosure. The paper direction is in parallel to the direction of vertical FOV of the LiDAR. FIG. 2 shows a top view of the example FMCW LiDAR, consistent with some embodiments of this disclosure. The paper direction is parallel to the direction of horizontal FOV of the LiDAR.

Referring to FIGS. 1 and 2, the FMCW LiDAR 10 includes a transceiver device 11, a beam shaper device 12, a scanning device 13 and a control device 14. The transceiver device 11 includes multiple ports (e.g., port 11-1, port 11-2, . . . , port 11-n shown in FIG. 1). The multiple ports are arranged at least along a first direction (e.g., arrow D in FIG. 1) and can respectively transmit the detection light L (e.g., the detection light L1, L2, . . . , Ln shown in FIG. 1) in a predetermined time sequence. The detection light L can be transmitted at the same predetermined time interval between adjacent-time ports.

The beam shaper device 12 can include a lens or lens group. For example, still referring to FIG. 1, the multiple ports can be located at different positions on a focal plane of the beam shaper device 12. The transmitted detection light L1, L2, . . . , Ln is incident on the beam shaper device, and the detection light is incident on the scanner device 13 after being collimated by the beam shaper device. The scanner device 13 can rotate around at least one axis. For example, still referring to FIG. 1 and FIG. 2, the scanner device 13 can rotate back and forth around the first axis (e.g., axis O-O in FIG. 1 and FIG. 2) in a direction indicated by arrow R. The scanner device 13 can have a reflection surface, and the detection light L from the beam shaper device 12 can be reflected to a target space (e.g., the space around the FMCW LiDAR 10).

In some embodiments, the FMCW LiDAR 10 can further include one or more other component, such as a light source, a detector, a signal processor circuit, or the like. For example, still referring to FIG. 1, ports 11-1 to 11-n of the transceiver device 11 are coupled with one or more lasers respectively. The ports receive the detection light transmitted by the laser and transmit the detection light. The detection light can be incident on an object where diffuse reflection occurs. Part of the detection light can return to the FMCW LiDAR 10 as the echo light. The detector can receive the echo light, and convert the light signal into an electrical signal. The signal processor circuit can receive and process the electrical signal. Distance and speed information of the object can be determined.

In some embodiments, still referring to FIG. 2, the scanner device 13 can rotate around the axis O-O. When the scanner device 13 is located at different angles, the detection light L1, L2, . . . , Ln can be reflected in different directions in a plane perpendicular to axis O-O. Because FIG. 2 shows a top view, projections of the detection light L1, L2, . . . , Ln in the drawings are coincident with each other. Timestamps t1, t2, t3, and t4 represent four different time points. The scanner device 13 reflects the detection light L1, L2, . . . . Ln in different directions in the plane perpendicular to the axis O-O, at different timestamps t1, t2, t3, and t4.

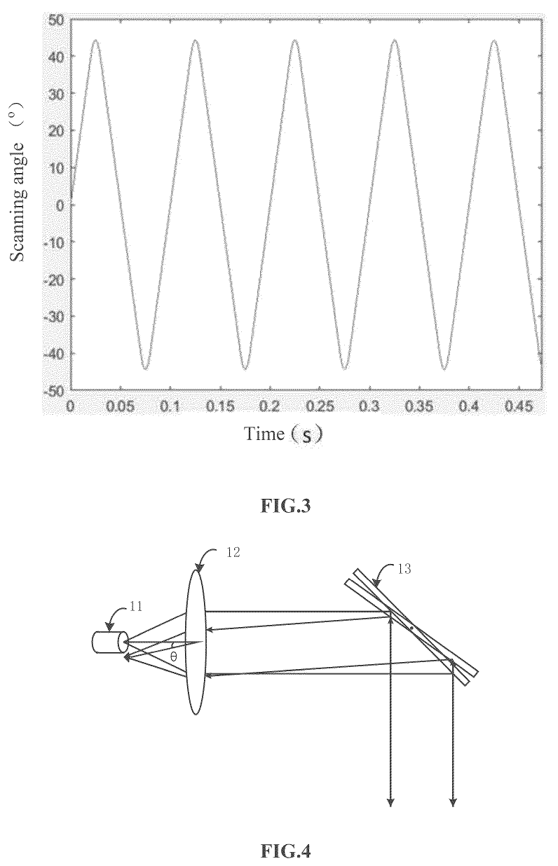

FIG. 3 shows an example scanning curve of the detection light beam of the example FMCW LiDAR, consistent with some embodiments of this disclosure. The example scanning curve represents possible change of the scanning angle with time in the plane perpendicular to the axis O-O of the scanner device 13. In some embodiments, the scanner device 13 can rotate in two directions around the axis O-O. The scanner device 13 can rotate at a constant speed between maximum swing amplitudes in the two directions.

In some embodiments, the multiple ports of the FMCW LiDAR 10 can work on an isochronous transmission mode. For example, the adjacent-time ports can transmit the detection light L at the same predetermined time interval. Still referring to FIG. 2, the interval between timestamps t1 to t2, the interval between timestamps t2 to t3, and the interval between timestamps t3 to t4 are the same. The arrow at timestamp t1 represents a light beam emitted after the detection light L transmitted at timestamp t1 passes through the beam shaper device 12 and scanner device 13. The arrow at timestamp t2 represents a light beam emitted after the detection light L transmitted at timestamp t2 passes through the beam shaper device 12 and scanner device 13, and so on. A possible scanning path of the FMCW LiDAR is shown in FIG. 3. In the plane perpendicular to the axis O-O, the scanning angle of the detection light of the LiDAR varies linearly with time between the maximum angles in the two directions (shown as ±45° in FIG. 3). Scanning with uniform angular resolution can be achieved. In addition, the adjacent-time ports can transmit the detection light at the same predetermined time interval. Different ports can be switched at the predetermined time interval. By doing so, difficulty in controlling the light source and the transceiver device can be reduced.

In some embodiments, the scanner device 13 can work on multiple scanning modes. The scanner device 13 can have different swing amplitudes, and/or rotation speeds, when the scanner device 13 work on the different scanning modes. For example, still referring to FIG. 1, the FMCW LiDAR 10 can include a controller device 14. The controller device can be electrically connected to the scanner device 13. The controller device 14 can control the scanner device 13 to switch among the multiple scanning modes.

The detection light can be reflected to different angle ranges by controlling different swing amplitude of the scanner device, when the adjacent-time ports transmit the detection light at the same predetermined time interval. The LiDAR can have different ranges for FOV angle in different scanning modes. By controlling different rotation speed of the scanner device, the emitting angle difference between two detection beams transmitted adjacent in the time sequence can be changed. The LiDAR can have different angular resolution in different scanning modes.

In some embodiments, the frame frequency of the FMCW LiDAR can be the same in different scanning modes. For example, the time taken by the scanner device 13 rotating from the maximum swing amplitude in one direction to the maximum swing amplitude in another direction in different scanning modes can be the same. In the same rotation period, the larger the swing amplitude of the scanner device is, the faster its rotation speed can be.

In some embodiments, multiple ports can sequentially transmit the detection light at the predetermined time interval. For example, at a time point, only one port transmits the detection light. Through the rotation of the scanner device, the detection light sequentially transmitted by the multiple ports can be reflected to different angles respectively. In a case that the scanner device rotates at a constant speed, the FOV of the LiDAR can be scanned with uniform angular resolution.

In some embodiments, the multiple ports can be divided into multiple groups. The ports belonging to a group can transmit light simultaneously. Respective groups of ports sequentially can transmit detection light at a predetermined time interval. For example, multiple ports in a group can transmit the detection light simultaneously. The detection light can be emitted at different angles after passing through the beam shaper device and the scanner device. Detection can be performed at multiple corresponding angles simultaneously. The FOVs corresponding to the emission angles of the detection light transmitted from different groups of ports can be stitched together through the rotation of the scanner device. The detection efficiency of the LiDAR can be improved.

In some embodiments, in a plane where the paper plane is located, the multiple ports can be arranged in a first direction D. The first direction D is parallel to the direction of vertical FOV of the FMCW LiDAR. The multiple ports can be arranged on a focal plane of the beam shaper device 12 along the first direction D. After passing through the beam shaper device 12, the detection light transmitted by each port can corresponds to a detection orientation of the vertical FOV of the LiDAR, respectively, as indicated by arrows of the detection light L1, L2, . . . , Ln shown in FIG. 1.

The sum of the detection orientations of the n ports forms the FOV in the vertical plane (“VFOV”) of the FMCW LiDAR 10, such as the FOV defined by the detection light L1 and Ln in FIG. 1.

In some embodiments, the axis O-O of the scanner device 13 is parallel to the first direction D. By rotation of the scanner device 13 around the axis O-O, the swing amplitude of the scanner device 13 corresponds to the FOV in the first plane of the FMCW LiDAR. The scanning FOV in the horizontal plane (“HFOV”) of the FMCW LiDAR 10 can be obtained, such as the FOV defined by the arrows corresponding to t1 and t4 in FIG. 2.

In some embodiments, still referring to FIGS. 1 and 2, the VFOV of the FMCW LiDAR 10 can be obtained by arranging the multiple ports along the first direction D (e.g., the first direction D is vertical direction). The HFOV of the FMCW LiDAR 10 can be obtained by the rotation of the scanner device 13 around the axis O-O. The definition of direction in the above description is only illustrative, the first direction D can be changed when the embodiments are implemented. For example, the first direction D can be determined in the horizontal plane. The HFOV of the FMCW LiDAR 10 can be obtained by arranging the multiple ports along the first direction D (e.g., the first direction D is horizontal direction), the VFOV of the FMCW LiDAR 10 can be obtained by the rotation of the scanner device 13 around the axis O-O.

In some embodiments, the FMCW LiDAR can include other scanner devices, or the scanner device can include a second axis not parallel to the first direction. The detection light can be deflected in a second plane not parallel to the first plane. For example, the second axis of the scanner device can be perpendicular to the first direction, or the LiDAR can include a second scanner device with a second axis. The second axis can be parallel to the direction of the horizontal FOV of the LiDAR. The rotation of the scanner device can be around the second axis. The detection light can be scanned to different angles in the vertical direction. By doing so, the VFOV of the LiDAR can be larger than the sum of the detection orientation of the n ports mentioned above.

In some embodiments, the swing amplitude of the scanner device 13 can correspond to a range for FOV angle of the FMCW LiDAR in the first plane. When the scanner device 13 rotates by an angle θ, the detection light rotates over optical angles 20. The range for FOV angle of the FMCW LiDAR in the first plane is twice the maximum angle difference generated by the swing amplitudes of rotation of the scanner device 13 in two directions. The swing amplitude of the scanner device 13 can be determined based on the range for FOV angle required by the FMCW LiDAR in the first plane.

In some embodiments, the axis of the scanner device 13 can be vertical, the first plane can be a horizontal plane. The maximum swing amplitude of the scanner device 13 can be determined by the magnitude of the HFOV of the FMCW LiDAR in the scanning mode. The difference between the maximum angles of rotation of the scanner device 13 in two directions can cause the detection light to be deflected by an angle of the HFOV.

In some embodiments, the port can receive echo light E (e.g., echo light E1, . . . , echo light En, as shown in FIG. 1) of the detection light L reflected by an object. For example, the FMCW LiDAR can be a LiDAR with a coaxial optical path, the port of FMCW LiDAR can transmit light and receive echo light.

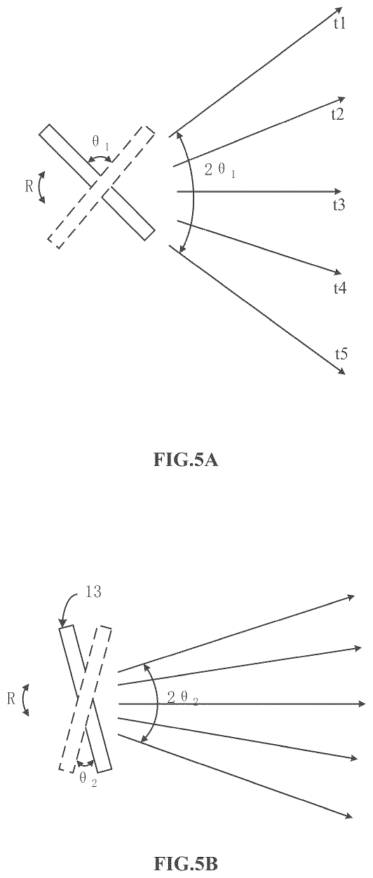

FIG. 4 shows an example schematic diagram illustrating generation of a delay angle of the LiDAR, consistent with some embodiments of this disclosure. Typically, the FOV of the LiDAR can be increased with the increasement of the scanning speed of the LiDAR. When the echo light is reflected by a distant object and incident on the LiDAR, the scanner device can have rotated by a certain angle. For example, referring to FIG. 4, a shift in the focus position of the echo light after being converged by the optical components is occurred. The shift can be a delay angle (e.g., angle θ in FIG. 4). The faster the rotation speed of the scanner device is, the greater the delay angle can be. The energy of the echo light, that can be received by the ports, can be reduced. The signal-to-noise ratio and long-distance detection capability can be reduced. The long-distance detection capability of the FMCW LiDAR can be negatively correlated with the scanning speed. Under a certain scanning frequency, the larger the FOV is, the smaller the measurement range can be.

In some embodiments, the rotation speed of the scanner device 13 can be determined based on at least one of the parameters of the FMCW LiDAR, such as a range for FOV angle in the first plane in current scanning mode, a maximum measurement range, a scanning period, a focal length of the beam shaper device, or mode field diameter of the ports.

In some embodiments, the ports can be optical fiber ports or waveguide ports.

In some embodiments, the frame frequency of LiDAR under different scanning modes can be constant. For example, the scanning time of one period can be fixed.

FIG. 5A shows an example first scanning mode of the scanner device, consistent with some embodiments of this disclosure. FIG. 5B shows an example second scanning mode of the scanner device, consistent with some embodiments of this disclosure.

Still referring to FIG. 3, the scanning time T of one period is fixed and T represents the period of triangular wave. Within time T, the scanner device can scan the HFOV twice in different directions. The optical angular velocity in rotation of the scanner device can be represented as ω=2HFOV/T. For example, referring to FIGS. 5A and 5B, the delay angle θ generated by rotation of the scanner device can satisfy θ=2zω/c. z represents a target distance and ω represents the optical angular velocity of the scanner device. When θ*f>Dfiber/2 (e.g., f represents a focal length of the lens, Dfiber represents a mode field diameter of the ports of the transceiver device), the focus of the echo light beam can deviate to the outside of the range of the mode field of the port. Coupling efficiency can be decreased.

In some embodiments, the rotation speed of the scanner device under different scanning modes satisfies the following relationship:

$$\frac{2 z ω}{c} \cdot f = \frac{4 z \cdot HFOV}{c \cdot T} < \frac{{D}_{fiber}}{2}$$

z represents the maximum measurement range of the FMCW LiDAR. ω represents an optical angular velocity of the scanner device. c represents a light speed. f represents the focal length of the beam shaper device. HFOV represents the range for FOV angle of the FMCW LiDAR in the first plane in current scanning mode. T represents the scanning period, and Dfiber represents the mode field diameter of the ports. By combining the focal length f of an optical system of the LiDAR and the mode field diameter Dfiber of the ports, the maximum measurement range z under a target FOV can be obtained.

In some embodiments, the multiple scanning modes can include at least a first scanning mode and a second scanning mode. The scanner device has a first rotation speed and a first swing amplitude in the first scanning mode. The scanner device has a second rotation speed and a second swing amplitude in the second scanning mode. The first rotation speed can be greater than the second rotation speed, the first swing amplitude can be larger than the second swing amplitude.

Still referring to FIGS. 5A and 5B, the scanner device 13 swings with a first swing amplitude θ₁ around the axis O-O in a first scanning mode. The scanner device 13 swings with a second swing amplitude θ₂ around the axis O-O, where θ₁ is greater than θ₂. In some embodiments, the scanner device 13 can perform a reciprocating scanning (e.g., the scanner device moves advance and return). The scanner device 13 can rotate reciprocatingly by ±½θ₁ and ±½θ₂ in two directions around the axis O-O, respectively. In the first scanning mode, the HFOV of the FMCW LiDAR 10 corresponding to the first swing amplitude θ₁ is 2θ₁. The arrows indicated at timestamps t1 and t5 correspond to the directions of the detection light reflected when the scanner device 13 is in the maximum swing positions in both directions in the first scanning mode. In the second scanning mode, the HFOV of the FMCW LiDAR 10 corresponding to the second swing amplitude θ₂ is 2θ2.

In some embodiments, referring to FIGS. 5A and 5B, the adjacent-time ports can transmit the detection light at the same predetermined time interval. When the rotation range (e.g., the rotation range can be related to swing amplitude) of the scanner device 13 is large, the scanning speed can be fast, and the angle between two detection light beams that are consecutively transmitted in the time sequence after being reflected by the scanner device 13 can be increased. A range for total angle at which each detection light beam can be deflected can be also increased. A large angle range and low angular resolution scan can be achieved. On the contrary, when the rotation range of the scanner device 13 is small, the scanning speed can be slow, and the angle between two detection light beams that are consecutively transmitted in the time sequence after being reflected by the scanner device can be decreased. A range for total angle at which each detection light beam can be deflected can also be decreased. A small angle range and high angular resolution scan can be achieved. For example, still referring to FIG. 5A, in the first scanning mode, the first swing amplitude θ1 of the scanner device 13 is large, and the rotation speed is large. The detection of a large FOV can be realized. In addition, the angle between detection light beams transmitted at adjacent (e.g., consecutive) time points after being reflected by the scanner device 13 is large. So the detection resolution of the scanner device 13 can be low (e.g., the spacing between the arrows of the detection light in FIG. 5A is large), and the detection mode of the scanner device 13 can be suitable for detecting short-distance objects. For example, still referring to FIG. 5B, in the second scanning mode, the second rotation range θ2 of the scanner device 13 is small and the rotation speed is large. The detection of a small FOV can be realized. In addition, the angle between detection light beams transmitted at adjacent time points after being reflected by the scanner device 13 is small. So the detection resolution can be high, and the detection mode can be suitable for detecting long-distance objects.

In this disclosure, it is easy for those skilled in the art to understand that the magnitude of the FOV can be a relative concept. Different FOVs can be determined based on the scanning requirements of the LiDAR. For example, HFOV can be 120° and 90°, or 90° and 60°. In addition, three or more scanning modes can be determined as needed. For example, the three scanning modes correspond to the FOV of 120°, 90°, and 30° can be determined.

In some embodiments, the measurement range in the first scanning mode can be smaller than the measurement range in the second scanning mode.

In some embodiments, different scanning modes can have different swing amplitudes and different rotation speeds, which is not limited in this disclosure. For example, different scanning modes can have different swing amplitudes, but have the same rotation speed. For another example, different scanning modes can have the same swing amplitude, but have different rotation speeds. In addition, the predetermined time interval for the multiple ports to transmit the detection light can be changed as need.

The scanner device 13 can operate in different scanning modes, such as the first scanning mode, the second scanning mode, or the like. In some embodiments, the controller device 14 can control the scanner device 13 to switch among different scanning modes, based on different schemes. For example, the controller device 14 can control the scanner device 13 to switch among different scanning modes based on one or more of detection range, detection result, detection scene, or the like. For example, the controller device 14 can switch scanning modes based on one or more of the following schemes. The scanner device can be switched to the second scanning mode when a moving speed of the FMCW LiDAR exceeds a speed threshold. The scanner device can be switched to the first scanning mode when the moving speed is below the speed threshold. The scanner device can be switched to the second scanning mode when a distance between an object and the FMCW LiDAR exceeds a predetermined distance threshold. The scanner device can be switched to the second scanning mode when the number of point clouds obtained through detection of objects by the FMCW LiDAR is lower than a predetermined point number threshold. The scanner device can be alternately switched between the first scanning mode and the second scanning mode based on a predetermined period.

In some embodiments, when the moving speed of the FMCW LiDAR exceeds the speed threshold (e.g., in the high-speed scenario), the scanner device can be switched to the second scanning mode. The measurement range of the LiDAR can be increased. For long-distance objects, scanning and detection can be performed with high resolution. When the moving speed of the FMCW LiDAR is lower than the speed threshold, the scenario can be the medium-low speed scenario (e.g., in the urban scene), the scanner device can be switched to the first scanning mode. For short-distance objects, scanning and detection can be performed with low resolution. Typically, the LiDAR can be installed on the vehicle. The moving speed of the LiDAR can be determined by obtaining the speed of the vehicle. In addition, the moving speed of the LiDAR can also be determined based on the point cloud measured by the LiDAR, which is not limited in this disclosure.

In some embodiments, the FMCW LiDAR can perform scanning in the first scanning mode, and switch to the second scanning mode. For example, the FMCW LiDAR can switch to the second scanning mode, when it is determined that the distance between the object and the FMCW LiDAR exceeds the predetermined distance threshold. For another example, the FMCW LiDAR can switch to the second scanning mode when the number of point clouds obtained by the FMCW LiDAR detecting the object is lower than the predetermined point threshold. For example, the first scanning mode can be used firstly for scanning and detection of a large range of FOV outside the LiDAR. Based on the detection results, when the detected object is at a distance exceeding the predetermined distance threshold (e.g., there is an object in a long distance away), the FMCW LiDAR can switch to the second scanning mode to improve resolution of the LiDAR and perform fine far-field detection. For another example, the number of point clouds obtained when LiDAR detects objects can be determined. When the number of point clouds is lower than the predetermined point threshold, the objects can be not recognized in the first scanning mode. The FMCW LiDAR can switch to the second scanning mode to detect the objects with high resolution. In this disclosure, the number of point clouds obtained by detecting objects and the object recognition ability can be improved.

In some embodiments, the LiDAR can alternatively switch between the first scanning mode and the second scanning mode. In some embodiments, the LiDAR can perform a scanning in the first scanning mode, then a scanning in the second scanning mode, and then continue a scanning pattern of the first scanning mode—the second scanning mode. In some embodiments, the LiDAR can perform N scanning in the first scanning mode, followed by M scanning in the second scanning mode, N>M, where N and M are positive integers.

In some embodiments, the transceiver device can further include a beam splitter module and an isolation module. The beam splitter module can be coupled to a light source of the FMCW LiDAR. The beam splitter module can receive a light signal from the light source and split the light signal into local oscillator light and the detection light. The isolation module can receive and output the detection light, and receive the echo light and separate an optical path of the echo light from an optical path of the detection light.

In some embodiments, the FMCW LiDAR can include a detector device and a transceiver device. The detector device can be coupled to the transceiver device. The detector device can receive the local oscillator light and the echo light. The detector device can convert the light signal into an electrical signal.

In some embodiments, the FMCW LiDAR can include a data processor. The data processor can sample the electrical signal outputted by the detector device.

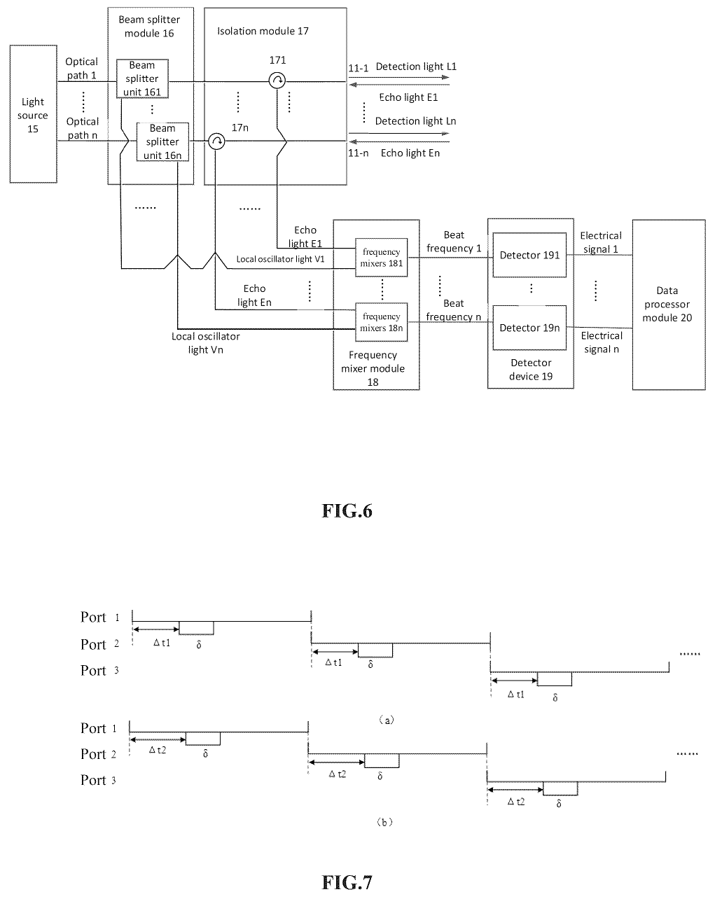

FIG. 6 shows a diagram illustrating an example structure of the FMCW LiDAR 10, consistent with some embodiments of this disclosure. The FMCW LiDAR 10 can include a beam shaper device and a scanner device, which are not shown in the FIG. 6.

Referring to FIG. 6, the FMCW LiDAR 10 includes a light source 15 and a transceiver device (not marked in the drawing). The transceiver device includes a beam splitter module 16 and an isolation module 17. The light source 15 can transmit a light signal, which is a frequency modulation continuous wave. The beam splitter module 16 is coupled with the light source. The beam splitter module 16 can split the light signal into local oscillator light and the detection light L. The isolation module 17 can receive and output the detection light L. The isolation module 17 can receive the echo light E and separate the optical path of the echo light from the optical path of the detection light.

For example, still referring to FIG. 6, the beam splitter module 16 includes multiple beam splitter units, the number of the beam splitter units corresponds to the number of ports of the transceiver device 11, such as the beam splitter units 161, . . . , 16n shown in FIG. 6. The isolation module 17 includes multiple isolation units, the number of the isolation units can also correspond to the number of ports of the transceiver device 11, such as isolation unit 171, . . . , isolation unit 17n as shown in FIG. 6. There is a one-to-one correspondence among the beam splitter units, the isolation units and ports. The laser emitted by the light source 15 can be switched among multiple paths, such as the optical path 1, . . . , optical path n as shown in the drawings, and the light signal in each optical path is incident into one of the beam splitter units. For example, the beam splitter unit 161 receives the light signal 1, and divides the light signal 1 into a local oscillator light V1 and a detection light L1. The detection light L1 is incident to a corresponding isolation unit 171 in the isolation module 17.

In some embodiments, the isolation unit includes a first end, a second end, and a third end. The first end is coupled with the beam splitter unit and can receive the detection light. The second end is coupled with ports of the transceiver device and can output the detection light and receive the echo light. The third end can output the echo light. Through isolation units of the isolation 17, the optical path of the echo light E is separated from the optical path of the detection light L.

In some embodiments, still referring to FIG. 6, the light signal emitted by the light source 15 is split into two parts by the beam splitter module. One small part is the local oscillator light, and the other part is the detection light transmitted to the outer space. A coaxial optical path is used in the LiDAR. A detection light signal is transmitted by a certain port of the transceiver device and is reflected by the object to generate an echo light signal. The echo light signal is received by the same port. The echo light signal is separated from the detection light signal through the isolation element.

The above describes the beam splitter unit 161, isolation unit 171, and port 11-1 as examples. Other beam splitter units, isolation units and ports are the same, which are not repeatedly described here.

In some embodiments, the beam splitter unit can include a coupler. The isolation unit can include a circulator, a polarization beam splitter element, or the like.

For example, still referring to FIG. 6, the FMCW LiDAR 10 can include a detector device (not marked in the drawings). The detector device includes a frequency mixer module 18, and a photoelectric converter module 19. The frequency mixer module 18 is coupled with the beam splitter module 16 and the isolation module 17 respectively. The frequency mixer module 18 can receive the local oscillator light and the echo light, and perform operation of beat frequency on the local oscillator light and the echo light to obtain a beat frequency signal. The photoelectric converter module 19 is coupled with the frequency mixer module 18. The photoelectric converter module 19 can receive the beat frequency signal and convert the light signal into an electrical signal.

For example, the frequency mixer module 18 includes n frequency mixers. The frequency mixer module 18 can perform operation of beat frequency on the local oscillating light and the echo light in each path to generate a beat frequency signal. The detection module 19 includes n photodetectors. The n photodetectors can receive beat frequency signal in each path, and perform photoelectric conversion to obtain the electrical signal.

Still referring to FIG. 6, the FMCW LiDAR 10 also includes a data processor 20. The data processor 20 can sample an electrical signal output by the detector.

At timestamp t1, a port 11-1 of the transceiver device 11 is switched on. The port 11-1 can start to transmit detection light L1 (e.g., FMCW signal), and stop transmitting detection light L1 at timestamp t2 when it is switched to another port (e.g., port 11-2). At this time, the port 11-2 can start to transmit detection light L2 (e.g., FMCW signal), or the like. In addition, it is easy for those skilled in the art to understand that it is not limited to transmit the detection light only by one port at each time point, and multiple ports can be controlled to transmit detection light simultaneously and receive echo light. The positional sequence of port for transmitting detection light is not limited to 11-1˜11-n, but can be flexibly configured by those skilled in the art based on the detection needs of FMCW LiDAR.

The FMCW LiDAR 10 can scan based on isochronous triggering mode. For example, the time interval from the triggering time for the port 11-1 to the triggering time for the port 11-2 can be fixed in different scanning modes. Because of the large amount of data can be processed based on ranging principle of the FMCW LiDAR 10, there is a lower limit t for the data processing time required to obtain one detection point. The parameter t is much larger than the delay time corresponding to echoes from a distance of 500 m. The interval of the switching times of the ports of the transceiver device is t. The maximum point frequency of channels can be obtained.

In some embodiments, the data processor 20 can sample an electrical signal output by the detector device. The sampling-start time in different scanning modes can be different and the durations of sampling in different scanning modes can be the same.

In some embodiments, the sampling-start time is related to the maximum measurement range of the FMCW LiDAR in the corresponding scanning mode. The FMCW LiDAR can transmit a continuous wave signal. The FMCW LiDAR can continuously or repeatedly transmit light in the operation window of port of the transceiver device. When it is reflected by objects, there is a continuous echo signal received by the LiDAR, and it continues until the reflected echo signal of the light signal last transmitted at last returns to the LiDAR. To reduce the amount of data processor, the beat frequency signal can be collected for a period of time, and the sampling-start time corresponds to the delay time of the echo from the farthest distance. At this time, even the echo signal reflected by an object at the farthest distance has already reached the LiDAR, the echo reflected by the object at a closer distance still exists.

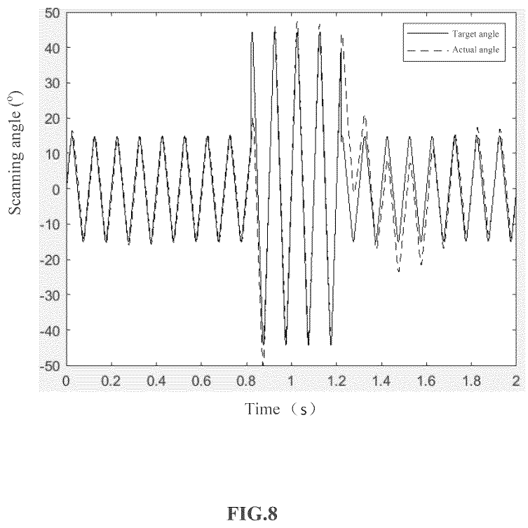

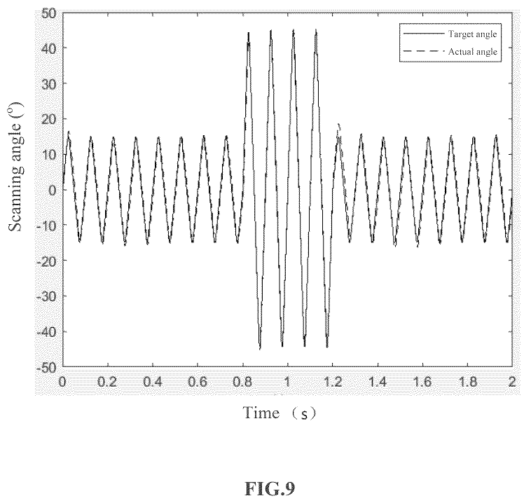

FIG. 7 shows an example including a sampling start time and duration in the first scanning mode and the second scanning mode, consistent with some embodiments of this disclosure. Referring to FIG. 7, (a) shows examples for the first scanning mode with a large FOV (e.g., with a short measurement range), and (b) shows examples for the second scanning mode with a small FOV (e.g., with large measurement range). In the first scanning mode, sample is started at timestamp Δt1, and the duration of sampling is δ, and the length of δ is determined based on the computing power, power consumption and signal-to-noise ratio of the LiDAR. In the second scanning mode, sample is started at timestamp Δt2 and the duration of sampling is δ, where Δt1<Δt2, and the duration 8 of sampling is the same in both scanning modes.

In some embodiments, the controller device can control the LiDAR to switch the scanning mode of the scanner device based on the scanning mode switching command.

FIG. 8 shows an example deviation between a target angle and an actual angle when switching scanning modes arbitrarily, consistent with some embodiments of this disclosure. When the scanning mode is switched at any time point, significant angle jitter in the scanner device can be caused when performing switching. For example, referring to FIG. 8, the scanning mode of the scanner device is switched during the rotation process. The actual angle value to deviate from expectation can be caused. Point cloud jitter and confusion can be caused. The detection accuracy can be reduced.

In some embodiments, the controller device can determine the angle of the scanner device based on the scanning mode switching command. For example, the controller device can determine whether the scanner device is in the 0° position (e.g., the zero point position in y-axis in FIG. 8).

In some embodiments, the controller device can determine whether to switch the scanning mode based on the angle of the scanner device. For example, when the scanner device deviates from the 0° position, the scanning mode can be not switched. When the scanner device is in the 0° position, the scanning mode can be switched based on the scanning mode switching command. During reciprocating rotation of a scanner device, the direction of the driving force acting on the scanner device when the scanner device rotates to a positive angle is different from that when the scanner device rotates to a negative angle, and the direction of the driving force switches at the 0° position. The scanning mode can be switched in parallel to switching the driving force. Jitter caused by the trajectory switching of the scanner device can be avoided or decreased.

FIG. 9 shows an example deviation between the target angle and the actual angle when switching scanning modes, consistent with some embodiments of this disclosure. The example effect is shown in FIG. 9, the scanning FOV is switched between 30° and 90°. Through the above method, the actual angle of the scanner device is basically consistent with the target angle.

In some embodiments, the scanner device 13 can include a reflecting mirror and a driver module. The driver module can drive the reflecting mirror to rotate around the axis O-O. The controller device 14 is connected with the driver module. The controller device 14 can control a current/voltage of the driver module based on the scanning mode to change the rotation speed and/or swing amplitude of the reflection device. The driver module can include a resonant motor, such as a voice coil motor. The resonant motor can include a rotor and a stator. The rotor rotates around the axis between an equilibrium position and the maximum swing amplitude.

In an existing voice coil motor, a mechanical model of the voice coil motor can be simplified to a second-order system of mass (m)-damping (c), and the transfer function from driving force to angle can be written as:

$$\frac{A ( x )}{F ( x )} = \frac{1}{m {s}^{2} + c s}$$

where A represents an angle, F represents a driving force, and s represents an operating frequency. The damping factor mainly comes from a frictional force of a bearing. Typically, the damping can be reduced as much as possible in the motor. In the case of low damping, the gain of the transfer function A(x)/F(x) is inversely proportional to the square of the frequency. For example, with the increase of the frequency, the dynamic gain of the conventional voice coil motor can be rapidly decreased. In the case that the frequency is fixed, if the scanning FOV is to be increased, with the increase of FOV, the acceleration speed in the scanning process increases. The required driving current becomes larger. The power consumption of the motor is proportional to the square of the driving current. In this disclosure, high power consumption can be achieved.

To make power consumption to be within an acceptable range when switching between different scanning modes, some example embodiments of this disclosure provide a resonant motor.

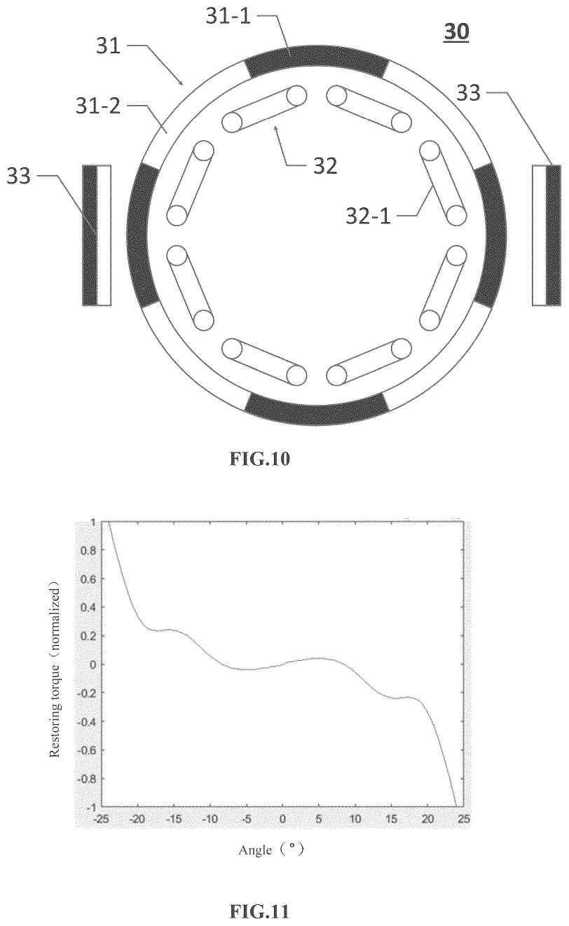

FIG. 10 shows a schematic diagram illustrating a resonant motor 30, consistent with some embodiments of this disclosure. For example, referring to FIG. 10, the resonant motor 30 includes a rotor 31 and a stator. The stator includes a coil assembly 32 and a restoring component 33.

The rotor 31 includes a magnetic ring. The magnetic ring includes multiple pairs of magnets, and the multiple pairs of magnets are distributed in a circumferential direction. For example, still referring to FIG. 10, each pair of magnets includes magnetic poles indicated by different gray levels (e.g., white and black), and different gray levels indicate different polarity (e.g., 31-1 and 31-2 in FIG. 10). The coil assembly 32 includes multiple winding coils 32-1 distributed in a circumferential direction of the magnetic ring. In some embodiments, the restoring component 33 includes two stator magnetic poles located on two opposite sides of rotor 31 in a radial direction, and the restoring component restores the rotor 31 to the equilibrium position around the axis. In particular, the axis of the rotor 31 is perpendicular to a line connecting the two stator magnetic poles included in the restoring component 33.

FIG. 10 illustrates the rotor 31 in the equilibrium position, and in the equilibrium position, the restoring component 33 has a polarity opposite to that of the magnet of a rotor 31 directly facing the restoring component 33. During the operation of the resonant motor 30, a current is injected into the coil assembly 32, and the magnetic field of the rotor 31 interacts with current in the coil assembly 32 to generate a driving torque, which rotates the rotor 31 from the equilibrium position to the direction of the maximum swing amplitude. When the rotor 31 deviates from the equilibrium position shown in FIG. 10, the attraction force generated between the magnets of the restoring component 33 and the rotor 31 with opposite polarities attracts rotor 31 back to the equilibrium position.

It should be noted that those skilled in the art would understand that although the rotor 31 shown in FIG. 10 is arranged outside of the coil assembly 32. In some embodiments, the rotor 31 can also be arranged inside of the coil assembly 32.

To reduce the power consumption as much as possible when scanning with a large FOV, the size of the restoring component and its distance from the rotor are determined such that the motor operates at the resonant point when scanning with the large FOV. Due to introduction of magnetic energy storage generated by the magnets of the restoring component and the rotor with opposite polarities, a large gain can be obtained at the resonant frequency point. Low power consumption can be achieved when scanning with the large FOV at a certain frequency. The larger the angle between the plane where the rotor and the stator are located (e.g., the angle of the mirror) and the line connecting the two stator magnetic poles is, the greater the restoring force the rotor receives. The normalized restoring force curve is shown in FIG. 11.

To improve the long-range measurement capability and angular resolution, the rotation speed and swing amplitude of the scanner device can be reduced to decrease the FOV. At this time, the angle between the plane where the rotor and coil assembly are located and the line connecting the two stator magnetic poles is very small. The restoring force is close to 0. The magnetic energy storage hardly can play a role, which is similar to the reciprocating operating mode of the conventional voice coil motor, which accelerates and decelerates by a driving current. In this case, the power consumption can be proportional to the square of the current. However, when the swing amplitude is small, a rotation speed of a moving part (e.g., mirror) can be low, combined with the low moment of inertia, the driving current required can be small. The power consumption is also low.

When scanning with the large FOV, the moving part rotates to a larger angle, the restoring force increases, and the magnetic field between the rotor and the restoring component generates a restoring torque, which provides additional driving force to the moving part. High-speed and large FOV scanning with low power consumption can be achieved.

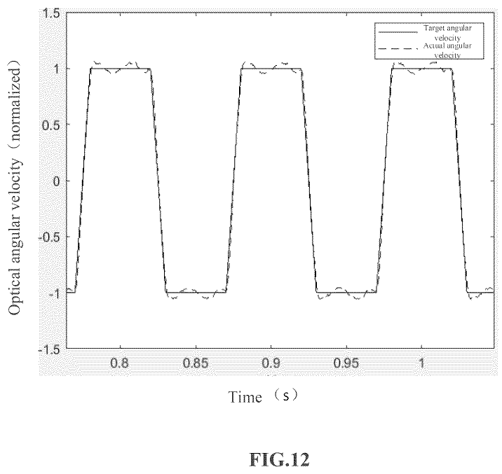

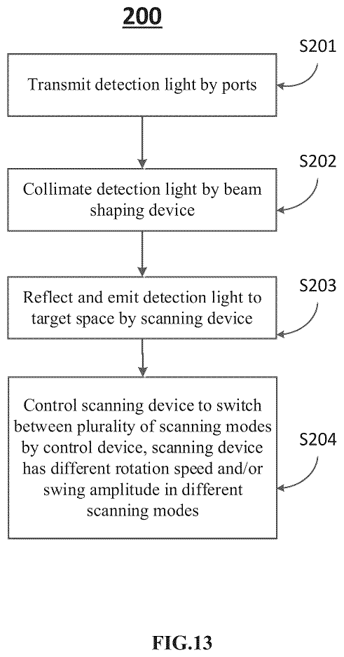

The normalized curve of the scanning speed is shown in FIG. 12. After positive-direction rotation for a certain time, it switches to negative-direction rotation. By using the scanner device based on the technical solution of this disclosure, uniform scanning under different FOV can be realized.

In some embodiments, still referring to FIG. 10, the rotor 31 is arranged outside the coil assembly 32. The distance between rotor 31 and the restoring component 33 can be small. The restoring force can be increased and the power consumption can be reduced during high-speed and large FOV scanning.

FIG. 13 shows an example scanning method for FMCW LiDAR, consistent with some embodiments of this disclosure. For example, referring to FIG. 13, this disclosure provides a scanning method 200 for a FMCW LiDAR. The FMCW LiDAR includes a transceiver device, a scanner device and a controller device. The transceiver device includes multiple ports arranged at least along a first direction. The FMCW LiDAR can be the FMCW LiDAR described in association to FIGS. 1-12. The following describes the method in detail with reference to FIG. 13.

At step S201, a detection light is transmitted by the ports.

At step S202, the detection light is collimated by a beam shaper device.

At step S203, the detection light is reflected and emitted into a target space by the scanner device.

At step S204, the scanner device is switched between multiple scanning modes by the controller device, where the scanner device has different rotation speeds and/or swing amplitudes in different scanning modes.

In some embodiments, the adjacent-time ports can transmit the detection light at the same predetermined time interval.

In some embodiments, the multiple ports can transmit the detection light at the predetermined time interval sequentially.

In some embodiments, the multiple ports can be divided into multiple groups, and respective groups of the ports transmit the detection light at the predetermined time interval sequentially.

In some embodiments, the ports can further receive an echo light of the detection light reflected by an object. The scanner device can reflect the echo light to the beam shaper device, and the beam shaper device can converge the echo light to the port.

In some embodiments, the rotation speed of the scanner device is related to a range for FOV angle of the FMCW LiDAR in current scanning mode, a maximum measurement range, a scanning period, a focal length of the beam shaper device, and mode field diameter of the ports.

In some embodiments, the rotation speed of the scanner device in different scanning modes can satisfy the following relationship:

$$\frac{2 z ω}{c} \cdot f = \frac{4 z \cdot HFOV}{c \cdot T} < \frac{{D}_{fiber}}{2}$$

z represents the maximum measurement range of the FMCW LiDAR, ω represents an optical angular velocity of the scanner device, c represents a light speed, f represents the focal length of the beam shaper device, HFOV represents the range for FOV angle of the FMCW LiDAR in the first plane in current scanning mode, T represents the scanning period, and Dfiber represents the mode field diameter of the ports.

In some embodiments, the multiple scanning modes can at least include a first scanning mode and a second scanning mode. The scanner device has a first rotation speed and a first swing amplitude in the first scanning mode. A second rotation speed and a second swing amplitude in the second scanning mode. The first rotation speed can be greater than the second rotation speed. The first swing amplitude can be greater than the second swing amplitude.

In some embodiments, the step of switching the scanner device between the multiple scanning modes can include switching the scanning mode based on one or more of a detection range, a detection result, or a detection scene.

In some embodiments, the predetermined condition can include one or more of the following: switching to the second scanning mode when a moving speed of the FMCW LiDAR exceeds a speed threshold; switching to the first scanning mode when the moving speed is below the speed threshold; switching to the second scanning mode when a distance between an object and the FMCW LiDAR exceeds a predetermined distance threshold, or when the number of point clouds obtained by the FMCW LiDAR detecting an obstacle is lower than a predetermined point number threshold; or alternately switching between the first scanning mode and the second scanning mode based on a predetermined period.

In some embodiments, the scanning method can further include sampling the electrical signal output by the detector device. Sampling-start times in different scanning modes can be different. Durations of sampling in different scanning modes are the same. The sampling-start time is related to a maximum measurement range of the FMCW LiDAR in a corresponding scanning mode.

In some embodiments, the step of switching the scanner device between the multiple scanning modes includes: switching between different scanning modes when the scanner device is at a 0° position.

It should be understood that each device or module or unit in the embodiments described in this disclosure can include one or more physical components in whole or in part. For example, a device or module or unit can be implemented as a processor, a controller, a computer, or any form of hardware components. As another example, a device or module or unit can include one or more hardware components and one or more software components. For example, the module can include a processor (e.g., a digital signal processor, microcontroller, field programmable gate array, a central processor, an application-specific integrated circuit, or the like) and a computer program, when the computer program is run on the processor, the function of the module can be realized. The computer program can be stored in a memory (e.g., a random-access memory, a flash memory, a read-only memory, a programmable read-only memory, a register, a hard disk, a removable hard disk, or a storage medium of any other form), or a server.

For example, a transceiver device can include a transceiver, a transceiver circuit, or the like. A beam shaper device can include a beam shaper, a beam shaper circuit, or the like. A scanner device can include a scanner, or the like. For example, the scanner can include a rotating mirror, an oscillating mirror, a swing mirror, a vibrating mirror, or the like. A controller device can include a controller, a controller circuit, or the like. A beam splitter module/unit can include a beam splitter, a beam splitting hardware component, or the like. An isolation module can include an isolator, a ring modulator, a polarization beam splitter, or the like. The beam splitter module and the isolation module can be implemented as the same components, such as a ring modulator, a polarization beam splitter, or the like. A frequency mixer module can include a frequency mixer, a frequency mixer circuit, a coupler, or the like. A photoelectric converter module can include a photoelectric converter, a photoelectric converter circuit, or the like. A data processor module can include a processor, a processor circuit, or the other like for processing data. A detector device can include a detector, a detector circuit, photodetectors, or the like. A driver module can include a driver, a resonant motor (e.g., voice coil motor), or the like. The number of the components of the above device or module or unit can be one or more. For example, the detector device can include one or more detectors.

In this disclosure, the terms “a,” “an,” “one,” and “the” are intended to represent singular or plural forms, unless expressly stated otherwise in the context. For example, without expressly stated otherwise in the context, “a transceiver” can refer to a single transceiver or a plurality of transceivers.

The terms “or” and “and/or” of this disclosure describe an association relationship between associated objects, and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the symbol “/” herein indicates that the associated objects before and after the character are in an “or” relationship. In this disclosure, the term “at least one of A or B” has a meaning equivalent to “A or B” as described above. The term “at least one of A, B, or C” has a meaning equivalent to “A, B, or C” as described above.

The term “multiple” in this disclosure refers to a number of two or more. For example, multiple objects can include two objects, or more than two objects. The term “at least one” in this disclosure refers to a number of one or more. For example, at least one object can include one object, or two objects, or ten objects, or the like.

Finally, it should be noted that the above description is only about example embodiments of this disclosure, which is not intended to limit this disclosure. Although detailed descriptions have been provided for the aforementioned embodiments, those skilled in the art can still modify the technical solutions described in the aforementioned embodiments or equivalently alternations can be made to some of the technical features. Any modifications, equivalent alternations, improvements, or the like made within the spirit and principle of this disclosure should be included within the protection scope of this disclosure.

1. An FMCW LiDAR, comprising:
a transceiver comprising a plurality of ports arranged at least along a first direction, the plurality of ports, comprising a first port, a second port and a third port, configured to transmit a detection light at a predetermined time sequence and receive an echo light of the detection light reflected from an object,
a beam shaper configured to collimate the detection light and converge the echo light onto the transceiver,
a scanner configured to rotate around at least one axis to reflect the detection light from the beam shaper to a space outside the FMCW LiDAR, and reflected the echo light to the beam shaper, and
a controller electrically connected to the scanner, and configured to control the scanner to switch among a plurality of scanning modes, the plurality of scanning modes comprising a first scanning mode with a first field of view and a first resolution, and a second scanning mode with a second field of view and a second resolution, wherein the scanner is configured to operate at a first rotation speed and a first swing amplitude in the first scanning mode, and operate at a second rotation speed and a second swing amplitude,
wherein the first port and the second port are configured to transmit the detection light at a predetermined time interval, and the second port and the third port are configured to transmit the detection light at the predetermined time interval.

2. The FMCW LiDAR of claim 1, wherein the plurality of ports are configured to transmit the detection light at the predetermined time interval sequentially.

3. The FMCW LiDAR of claim 1, wherein the plurality of ports are divided into a plurality of groups comprising a first group, a second group, and a third group, wherein
the first group and the second group are configured to transmit the detection light at the predetermined time interval, and the second group and the third group are configured to transmit the detection light at the predetermined time interval.

4. The FMCW LiDAR of claim 1, wherein the scanner is configured to rotate around a first axis to reflect the detection light to different angles in a first plane, wherein the first axis is parallel to the first direction, and the first plane is perpendicular to the first direction.

5. The FMCW LiDAR of claim 4, wherein the first swing amplitude or the second swing amplitude corresponds to a field of view range of the FMCW LiDAR in the first plane.

6. The FMCW LiDAR of claim 5, wherein the first rotation speed is related to a field of view range of the FMCW LiDAR in the first plane, a maximum measurement range, a scanning period, a focal length of the beam shaper, and mode field diameter of the plurality of the ports in the first scanning mode, and
the second rotation speed is related to the field of view range of the FMCW LiDAR in the first plane, the maximum measurement range, the scanning period, the focal length of the beam shaper, and mode field diameter of the plurality of the ports in the second scanning mode.

7. The FMCW LiDAR of claim 6, wherein the first rotation speed satisfies the following relationship:
$$\frac{2 z ω}{c} \cdot f = \frac{4 z \cdot HFOV}{c \cdot T} < \frac{{D}_{fiber}}{2}$$
where z represents the maximum measurement range of the FMCW LiDAR, œ represents an optical angular velocity of the scanner, c represents a light speed, f represents the focal length of the beam shaper, HFOV represents the field of view range of the FMCW LiDAR in the first plane in the first scanning mode, T represents the scanning period, and Dfiber represents the mode field diameter of the plurality of ports in the first scanning mode.

8. The FMCW LiDAR of claim 1, wherein the first rotation speed is greater than the second rotation speed, and the first swing amplitude is greater than the second swing amplitude.

9. The FMCW LiDAR of claim 8, wherein the controller is further configured to switch the first scanning mode to the second scanning mode based on one or more of a detection range, a detection result, or a detection scene.

10. The FMCW LiDAR of claim 9, wherein the controller is configured to switch among the plurality of scanning modes in response to at least one of:
a moving speed of the FMCW LiDAR exceeds a speed threshold,
the moving speed falls below the speed threshold,
a distance between the object and the FMCW LiDAR exceeds a predetermined distance threshold, or
a number of points obtained by detecting the object through the FMCW LiDAR is lower than a predetermined point number threshold.

11. The FMCW LiDAR of claim 9, wherein the controller is configured to alternately switch between the first scanning mode and the second scanning mode based on a predetermined period.

12. The FMCW LiDAR of claim 1, further comprising a light source, wherein the transceiver further comprises a beam splitter and an isolator, the beam splitter is coupled to the light source and is configured to split a light of the light source into a local oscillator light and the detection light, and wherein the isolator is configured to receive and output the detection light, receive the echo light, and separate an optical path of the echo light from an optical path of the detection light.

13. The FMCW LiDAR of claim 1, further comprising a detector coupled to the transceiver, wherein the detector is configured to receive the local oscillator light and the echo light and to output an electrical signal.

14. The FMCW LiDAR of claim 13, further comprising a data processor configured to sample the electrical signal, wherein the first scanning mode is configured to initiate sampling at a first sampling-start time with a sampling duration, and the second scanning mode is configured to initiate sampling at a second sampling start time with the sampling duration.

15. The FMCW LiDAR of claim 14, wherein the first sampling-start time is related to a maximum measurement range of the FMCW LiDAR in the first scanning mode, and
the second sampling-start time is related to the maximum measurement range of the FMCW LiDAR in the second scanning mode.

16. The FMCW LiDAR of claim 1, wherein the controller is further configured to switch among the plurality of scanning modes in response to the scanner is at a 0° position.

17. The FMCW LiDAR of claim 1, wherein the scanner comprises:
a reflector, and
a driver configured to drive the reflector to rotate round the at least one axis,
wherein the controller is coupled to the driver and configured to control a current or a voltage of the driver, to cause the reflector to rotate at the first rotation speed and the first swing amplitude in the first mode, and to rotate at the second rotation speed and the second swing amplitude in the second mode.
